(19) United States
(12) Patent Application Publication
(10) Pub. No.: US 2023/0307161 A1
(43) Pub. Date: Sep. 28, 2023

(54) Magnetic Bead

(71) Applicant: SEIKO EPSON CORPORATION, Tokyo (JP)

(72) Inventors: Michio NAKAMORI, Matsumoto (JP); Yasunari IKEDA, Shiojiri (JP); Sukenori ICHIKAWA, Suwa (JP)

(21) Appl. No.: 18/188,593

(22) Filed: Mar. 23, 2023

(30) Foreign Application Priority Data
Mar. 24, 2022 (JP) 2022-048149

(51) Int. Cl. H01F 1/147

(52) U.S. Cl. CPC H01F 1/14766

(57) ABSTRACT

A magnetic bead includes: a magnetic metal powder; and a coating layer that covers a particle surface of the magnetic metal powder, has an average thickness of 20 nm or more, and is made of an oxide material. A coercive force is 1.0 Oe, which is equal to 80 A/m, or less. The magnetic metal powder may contain an amorphous structure or a nanocrystalline structure. The magnetic metal powder may be made of an alloy containing Fe as a main component.

The present application is based on, and claims priority from JP Application Serial Number 2022-048149, filed Mar. 24, 2022, the disclosure of which is hereby incorporated by reference herein in its entirety.

### BACKGROUND

### 1. Technical Field

The present disclosure relates to a magnetic bead.

### 2. Related Art

In recent years, in diagnosis in the medical field and in the field of life science, there has been an increasing demand for testing biological substances. Among biological substance testing methods, polymerase chain reaction (PCR) is a method of extracting nucleic acids such as DNA and RNA, and specifically amplifying and detecting the nucleic acids. In a process of testing such a biological substance, it is necessary to first extract a substance to be tested from a specimen. For the extraction of the biological substance, magnetic separation using magnetic beads is widely used. In magnetic separation, a biological substance to be extracted is extracted by applying a magnetic field using magnetic beads having a function of carrying the biological substance to be extracted. Specifically, the magnetic beads having the function of carrying the substance to be tested on surfaces of the magnetic beads are dispersed in a dispersion medium, then the obtained dispersion liquid is attached to a magnetic field generation device such as a magnetic stand, and ON/OFF of magnetic field application is repeated a plurality of times. Accordingly, the substance to be tested is extracted. Since such magnetic separation is a method of separating and collecting magnetic beads by a magnetic force, a rapid separation operation can be performed.

The magnetic separation is used not only in the extraction in the PCR method but also in the fields of protein purification, separation and extraction of exosomes and cells, or the like.

For example, JP-A-2010-156054 discloses, as metal fine particles for magnetic beads, metal fine particles in which magnetic metal particle nuclei having a particle diameter of 10 μm or less on average and containing a magnetic metal as a main component are covered with two or more different inorganic materials in a multilayer manner. According to such metal fine particles, since the magnetic metal particle nuclei are covered with the inorganic materials in the multilayer manner, especially when the magnetic metal particle nuclei are small, it contributes to high saturation magnetization of all the particles.

However, the metal fine particles disclosed in JP-A-2010-156054 may have high saturation magnetization and a high coercive force. When the coercive force is high, residual magnetization increases, and thus the magnetic beads are likely to aggregate. As a result, re-dispersibility of the magnetic beads may decrease. When the re-dispersibility of the magnetic beads decreases, washing efficiency of the magnetic beads decreases, which leads to a decrease in purity of nucleic acids. Therefore, it is an object of the present disclosure to implement magnetic beads having excellent re-dispersibility.

### SUMMARY

A magnetic bead according to an application example of the present disclosure includes: a magnetic metal powder; and a coating layer that covers a particle surface of the magnetic metal powder, has an average thickness of 20 nm or more, and is made of an oxide material. A coercive force is 1.0 Oe, which is equal to 80 A/m, or less.

### BRIEF DESCRIPTION OF THE DRAWINGS

FIG. 1 is a cross-sectional view showing a magnetic bead according to an embodiment.

FIG. 2 is a graph showing a correlation between an average thickness t of a coating layer and a coercive force Hc of magnetic beads.

FIG. 3 is a graph showing a correlation between the average thickness t of the coating layer and evaluation results of re-dispersibility of the magnetic beads.

### DESCRIPTION OF EXEMPLARY EMBODIMENTS

Hereinafter, a preferred embodiment of a magnetic bead according to the present disclosure will be described in detail with reference to the accompanying drawings.

### 1. Magnetic Bead

The magnetic bead according to the embodiment is a particle group that includes a magnetic metal powder and a coating layer covering a particle surface of the magnetic metal powder, adsorbs a biological substance, and is used for magnetic separation. The magnetic separation is a method of separating a solid phase containing a magnetic bead and a liquid phase containing a liquid by applying an external magnetic field to a container containing the solid phase and the liquid phase and magnetically attracting the solid phase. In the present specification, the magnetic bead refers to a particle group or one particle constituting the particle group.

Examples of the biological substance include substances such as nucleic acids (such as DNA and RNA), proteins, saccharides, various cells (such as cancer cells), peptides, bacteria, and viruses. The nucleic acid may be present in a state of being contained in, for example, a biological sample such as a cell or a biological tissue, a virus, or a bacterium. The magnetic bead according to the embodiment is used for purification of the biological substance utilizing the magnetic separation between the magnetic bead and a liquid when such a biological substance is extracted through steps of dissolution and adsorption, separation, washing, and elution.

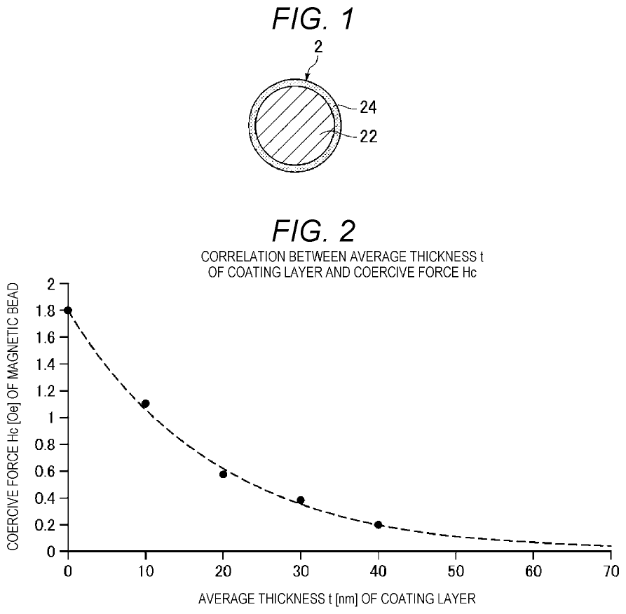

FIG. 1 is a cross-sectional view showing a magnetic bead 2 according to the embodiment. As shown in FIG. 1, the magnetic bead 2 is a particle including a magnetic metal powder 22 and a coating layer 24 that covers a particle surface of the magnetic metal powder 22. Since the magnetic metal powder 22 has magnetism, when an external magnetic field acts on the magnetic bead 2, the magnetic metal powder 22 generates a magnetic attractive force and is captured by the external magnetic field. As described later, the coating layer 24 has an average thickness of 20 nm or more and is made of an oxide material. As described later, the coating layer 24 has a function of adsorbing the biological substance. The magnetic bead 2 has a coercive force Hc of 1.0 Oe (80 A/m) or less.

The coercive force Hc refers to a value of an external magnetic field in an opposite direction required to return a magnetized magnetic material to an unmagnetized state. That is, the coercive force Hc means a resistance force against the external magnetic field. In the magnetic bead 2 having the coercive force Hc within the above range, residual magnetization is kept to be low. Then, the magnetic bead 2 is magnetized by the application of the external magnetic field and then when the external magnetic field is turned off, the magnetic bead 2 exhibits good re-dispersibility in a dispersion liquid. As a result, when the magnetic bead 2 to which the biological substance is adsorbed is brought into contact with a washing liquid and washed, or when the biological substance adsorbed to the magnetic bead 2 is eluted into an eluate, washing efficiency or elution efficiency can be enhanced. As a result, it is possible to prevent occurrence of washing failure or elution failure and extract a high-purity biological substance at a high yield.

The coercive force Hc of the magnetic bead 2 is preferably 1.0 Oe (80 A/m) or less, and more preferably 0.8 Oe (64 A/m) or less.

A lower limit value of the coercive force Hc of the magnetic bead 2 is not particularly limited, and is preferably 0.01 Oe (0.8 A/m) or more from the viewpoint of ease of material selection suitable for a balance between performance and cost.

The coercive force Hc of the magnetic bead 2 can be measured by a vibrating sample magnetometer (VSM) or the like. Examples of the vibrating sample magnetometer include TM-VSM1230-MHHL manufactured by Tamakawa Co., Ltd. A maximum applied magnetic field at the time of measuring the coercive force Hc is, for example, 15 kOe. A measurement condition is a sweep slow condition. The magnetic bead 2 is used for measurement in a state of filling a cylindrical plastic case having an inner diameter of 7 mm and a length of 5 mm.

The saturation magnetization of the magnetic bead 2 is preferably 50 emu/g or more, and more preferably 100 emu/g or more. The saturation magnetization is a value of magnetization exhibited by a magnetic material when a sufficiently large magnetic field is applied from outside is constant regardless of the magnetic field. As the saturation magnetization of the magnetic bead 2 is higher, the function thereof as the magnetic material can be exhibited more sufficiently. Specifically, since a moving speed of the magnetic bead 2 in a magnetic field can be increased, a time required for the magnetic separation can be shortened. The saturation magnetization of the magnetic bead 2 affects an adsorption force when the magnetic bead 2 is fixed by the external magnetic field. When the saturation magnetization is within the above range, a sufficiently high adsorption force can be obtained. Therefore, when a magnetically separated liquid is discharged, discharge of the magnetic bead 2 together with the liquid can be prevented. Accordingly, it is possible to prevent a decrease in the yield of the biological substance due to a decrease in the amount of the magnetic bead 2.

An upper limit value of the saturation magnetization of the magnetic bead 2 is not particularly limited, and is preferably 220 emu/g or less from the viewpoint of ease of material selection suitable for a balance between performance and cost.

The saturation magnetization of the magnetic bead 2 can be measured by a vibrating sample magnetometer or the like. Examples of the vibrating sample magnetometer include TM-VSM1230-MHHL manufactured by Tamakawa Co., Ltd. A maximum applied magnetic field at the time of measuring the saturation magnetization is, for example, 0.5 T or more.

Relative permeability of the magnetic bead 2 is preferably 5 or more. When the relative permeability of the magnetic bead 2 is less than the lower limit value, the moving speed of the magnetic bead 2 may decrease, and the time required for the magnetic separation may increase. The upper limit value of the relative permeability of the magnetic bead 2 is not particularly limited. Since the magnetic bead 2 is in a powder form, the relative permeability often takes a value of substantially 100 or less due to an influence of a demagnetizing field.

An average particle diameter of the magnetic bead 2 is preferably 0.5 μm or more and 50 μm or less, more preferably 1 μm or more and 30 μm or less, and still more preferably 2 μm or more and 20 μm or less. When the average particle diameter of the magnetic bead 2 is within the above range, a specific surface area of the magnetic bead 2 can be sufficiently increased, and a mass and the saturation magnetization of the magnetic bead 2 are suitable for the magnetic separation. That is, it is possible to obtain the magnetic bead 2 having a specific surface area enabling adsorbing a sufficient amount of the biological substance and exhibiting a magnetic attractive force excellent in the moving speed in magnetism. Aggregation of the magnetic beads 2 can be prevented, and the re-dispersibility can be enhanced.

When the average particle diameter of the magnetic bead 2 is less than the lower limit value, a value of the magnetization of the magnetic bead 2 is small, and the magnetic beads 2 are likely to aggregate. As a result, extraction efficiency of the biological substance may decrease. The moving speed of the magnetic bead 2 in the magnetic separation may decrease, and the time required for the magnetic separation may increase. On the other hand, when the average particle diameter of the magnetic bead 2 exceeds the upper limit value, the specific surface area of the magnetic bead 2 is small. Therefore, a sufficient amount of the biological substance cannot be absorbed, which may reduce an extraction amount of the biological substance. The magnetic bead 2 is likely to settle, and the amount of the magnetic bead 2 that can contribute to the extraction of the biological substance decreases, which may reduce the extraction efficiency of the biological substance.

A volume-based particle size distribution can be measured by a laser diffraction and dispersion method, and the average particle diameter of the magnetic bead 2 can be obtained based on a cumulative distribution curve obtained based on the particle size distribution. Specifically, in the cumulative distribution curve, a particle diameter D50 (median diameter) at which a cumulative value is 50% from a small diameter side is the average particle diameter of the magnetic bead 2. Examples of a device that measures the particle size distribution by the laser diffraction and dispersion method include Microtrac MT3000II series manufactured by Microtrac BEL Corporation. The method is not limited to the laser diffraction and dispersion method, and a method such as image analysis may be used.

When an average thickness of the coating layer 24 is t and the average particle diameter of the magnetic bead 2 is D50, a ratio t/D50 of t to D50 is preferably 0.0001 or more and 0.05 or less, and more preferably 0.001 or more and 0.01 or less. When the t/D50 is less than the lower limit value, a ratio of the thickness of the coating layer 24 to the size of the magnetic metal powder 22 is too small. Therefore, when a collision between the magnetic beads 2 or a collision between the magnetic bead 2 and an inner wall of a container or the like occurs, the coating layer 24 may be broken or peeled off. Therefore, an amount of the extracted biological substance adsorbed on the surface of the coating layer 24 may decrease, and the extraction efficiency may decrease. In addition, fragments of the peeled coating layer 24 and the magnetic metal powder 22 are present in the dispersion liquid, and may be mixed as impurities (contamination) at the same time when the biological substance is taken out. Further, the magnetic metal powder 22 is exposed due to breaking and peeling of the coating layer 24, and elution of iron ions or the like occurs when the magnetic metal powder 22 is brought into contact with an acidic solution or the like. As a result, the extraction efficiency of the biological substance may decrease. On the other hand, when the t/D50 exceeds the upper limit value, a volume ratio of the coating layer 24 to an entire volume of the magnetic bead 2 is large, and the magnetization per volume of the magnetic bead 2 may decrease. Accordingly, the moving speed of the magnetic bead 2 when the external magnetic field acts thereon decreases, and the time required for the magnetic separation may increase.

### 1.1. Magnetic Metal Powder

The magnetic metal powder 22 is magnetic particles, and preferably contains at least one of Fe, Co, and Ni as a constituent element. In particular, from the viewpoint of obtaining high saturation magnetization, a composition of the magnetic metal powder 22 is preferably an alloy containing Fe as a main component (Fe-based alloy). Specifically, an atomic ratio of Fe is more preferably 50% or more, and still more preferably 70% or more. The composition of the magnetic metal powder 22 may be an alloy containing Fe as the main component (Fe-based alloy), and examples thereof include a Fe—Co-based alloy, a Fe—Ni-based alloy, a Fe—Co—Ni-based alloy, and a compound containing Fe, Co, and Ni. From the viewpoint of obtaining high magnetization, a carbonyl iron powder, a Fe—Si-based alloy powder, a Fe—Si—Cr-based alloy powder, or the like containing substantially 100 mass % of Fe is preferably used as the magnetic metal powder 22. Use of such a Fe-based alloy can implement the magnetic metal powder 22 having high saturation magnetization and high magnetic permeability even when the particle diameter is small. Accordingly, it is possible to implement the magnetic beads 2 having a high moving speed due to the action of the external magnetic field and having a large magnetic adsorption force when captured by the external magnetic field. As a result, the time required for magnetic separation can be shortened, and the magnetic bead 2 can be prevented from being mixed into the eluate and becoming impurities.

The Fe-based alloy can contain one element or two or more elements selected from the group consisting of Cr, Nb, Cu, Al, Mn, Mo, Si, Sn, B, C, P, Ti, and Zr, depending on the intended characteristics, in addition to elements exhibiting ferromagnetism alone, such as Co or Ni as described above. Si is a main constituent element in an alloy powder, and is also an element that promotes amorphization.

The Fe-based alloy may contain impurities as long as the effects of the magnetic metal powder 22 are not impaired. The impurities in the embodiment are elements that are unintentionally mixed in the raw material of the magnetic metal powder 22 or mixed at the time of manufacturing the magnetic beads 2. The impurities are not particularly limited. Examples thereof include O, N, S, Na, Mg, and K.

An example of the Fe-based alloy is an alloy having a Si content of preferably 1.0 atomic % or more and 30.0 atomic % or less, more preferably 1.5 atomic % or more and 15.0 atomic % or less, and still more preferably 2.0 atomic % or more and 13.0 atomic % or less. Since such an alloy has high magnetic permeability, the saturation magnetization tends to be high.

The Fe-based alloy may contain at least one of B (boron) having a content of 5.0 atomic % or more and 16.0 atomic % or less and C (carbon) having a content of 0.5 atomic % or more and 5.0 atomic % or less. These are elements that promote the amorphization, and contribute to formation of a stable amorphous structure or nanocrystalline structure in the magnetic metal powder 22.

Further, the Fe-based alloy preferably contains Cr (chromium) having a content of 1.0 atomic % or more and 8.0 atomic % or less. Accordingly, corrosion resistance of the magnetic metal powder 22 can be enhanced.

A total content of impurities is preferably 1.0 atomic % or less. At this level, even when the impurities are contained, the effects of the magnetic metal powder 22 are not impaired.

An example of a particularly preferred Fe-based alloy is an alloy containing Fe as a main component and having a Si content of 2.0 mass % or more and 9.0 mass % or less, a B content of 1.0 mass % or more and 5.0 mass % or less, and a Cr content of 1.0 mass % or more and 3.0 mass % or less. Since such a Fe-based alloy contains a stable amorphous structure, the coercive force is low, and since the Fe content is high, the saturation magnetization is high. Since the corrosion resistance is improved by containing Cr, the elution of the iron ions can be prevented. Since the iron ions may adversely affect testing of the biological substance, it is preferable that the elution thereof is prevented.

The constituent elements and the composition of the magnetic metal powder 22 can be identified by an ICP emission spectrometry defined in JIS G 1258:2014, a spark emission spectrometry defined in JIS G 1253:2002, or the like. When the magnetic metal powder 22 is covered with the coating layer 24, the constituent elements and the composition can be measured by the above method after the coating layer 24 is removed by a chemical or physical method. When it is difficult to remove the coating layer 24, for example, the magnetic bead 2 is cut, and then a core portion of the magnetic metal powder 22 can be analyzed by an analysis device such as an electron probe micro analyzer (EPMA) or an energy dispersive X-ray spectroscopy (EDX).

A Vickers hardness of the magnetic metal powder 22 is preferably 100 or more, more preferably 300 or more, and still more preferably 800 or more. A method of measuring the hardness of the magnetic metal powder 22 is, for example, as follows. A plurality of particles of the magnetic metal powder 22 are taken out and embedded in a resin to produce a resin-embedded sample, and then a cross section of the magnetic metal powder 22 obtained by grinding and polishing appears on a surface of the resin-embedded sample. An indentation is made on the cross section of the magnetic metal powder by using a micro Vickers tester, a nanoindenter, or the like, and the hardness is measured based on a size of the indentation.

When the Vickers hardness of the magnetic metal powder 22 is less than the lower limit value, the magnetic metal powder 22 may be plastically deformed due to an impact caused by the magnetic beads 2 colliding with one another. When the plastic deformation occurs, the coating layer 24 may peel off or fall off. An upper limit of the Vickers hardness is not particularly limited, and is preferably 3000 or less from the viewpoint of ease of material selection suitable for a balance between performance and cost.

A main metal structure constituting the magnetic metal powder 22 can take various forms such as a crystalline structure, an amorphous structure, and a nanocrystalline structure. The amorphous structure refers to an amorphous structure in which no crystal is present. The nanocrystalline structure refers to a structure mainly formed of fine crystals having a crystal grain diameter of 100 nm or less. The magnetic metal powder 22 preferably contains an amorphous structure or a nanocrystalline structure in particular. The amorphous structure and the nanocrystalline structure give a high hardness to the magnetic metal powder 22. When the amorphous structure or the nanocrystalline structure is used, the coercive force Hc of the magnetic bead 2 is a particularly low value, which contributes to the improvement of the re-dispersibility of the magnetic bead 2. A volume fraction of the amorphous structure or the nanocrystalline structure in the magnetic metal powder 22 is preferably 40% or more, and more preferably 60% or more. The volume fraction is determined based on a result of crystal structure analysis by X-ray diffraction. The crystalline structure, the amorphous structure, and the nanocrystalline structure may be present alone, or may be a structure in which two or more of these structures are mixed.

The metal structure of the magnetic metal powder 22 can be identified by performing the crystal structure analysis by the X-ray diffraction method on the magnetic metal powder 22. Further, the metal structure can be identified by analyzing a structure observation image or a diffraction pattern of a cut-out sample using a transmission electron microscope (TEM). More specifically, in the case of the amorphous structure, for example, a diffraction peak derived from a metal crystal such as an α-Fe phase is not observed in peak analysis in the X-ray diffraction method. In the case of the amorphous structure, a so-called halo pattern is formed in an electron beam diffraction pattern obtained by the TEM, and formation of a spot by crystal is not observed. The nanocrystalline structure is formed of a crystalline structure having a particle diameter of, for example, 100 nm or less, and can be confirmed from a TEM observation image. More precisely, an average particle diameter can be calculated by an image process or the like based on a plurality of TEM structure observation images in which a plurality of crystals are present. The crystal grain diameter can be estimated by a Sherer method based on the diffraction peak of the crystal phase to be analyzed by the X-ray diffraction method. Further, for a crystalline structure having a large particle diameter, the crystal grain diameter can be measured by a method such as observing a cross section using an optical microscope or a scanning electron microscope (SEM).

In order to obtain the amorphous structure and the nanocrystalline structure, it is effective to increase a cooling rate when a molten raw material is pulverized and then cooled in the case of manufacturing the magnetic metal powder 22. Ease of formation of the amorphous structure and the nanocrystalline structure also depends on the alloy composition. As a specific alloy system suitable for forming the amorphous structure and the nanocrystalline structure, a composition in which one or more selected from the group consisting of Cr, Si, B, C, P, Nb, and Cu are added to Fe is preferred.

### 1.2. Coating Layer

As shown in FIG. 1, the coating layer 24 covers the particle surface of the magnetic metal powder 22. The coating layer 24 may be formed on at least a part of the particle surface of the magnetic metal powder 22, and preferably covers the entire particle surface.

A main function of the coating layer 24 is to adsorb the biological substance. From this viewpoint, the coating layer 24 is made of an oxide material.

Examples of the oxide material constituting the coating layer 24 include silicon oxide, aluminum oxide, titanium oxide, vanadium oxide, niobium oxide, chromium oxide, manganese oxide, tin oxide, and zirconium oxide. Among these, one type or a mixture of two or more types thereof is used.

Among these, the oxide material constituting the coating layer 24 preferably contains a silicon oxide. The silicon oxide is a substance particularly suitable for extraction of nucleic acids such as DNA and RNA. In a composition formula, for example, SiOx (0<x≤2) is preferred, and specifically, SiO₂ is preferred. Such a silicon oxide enables extraction and collection of the nucleic acids by specifically adsorbing the nucleic acids in an aqueous solution containing a chaotropic substance. The “chaotropic substance” is a substance that has a function of increasing water solubility of hydrophobic molecules and contributes to nucleic acid adsorption. Specific examples of the chaotropic substance include guanidine hydrochloride, sodium iodide, and sodium perchlorate.

The oxide material may be a composite oxide or composite of silicon and one oxide or two or more oxides selected from the group consisting of Al, Ti, V, Nb, Cr, Mn, Sn, and Zr. Al, Ti, V, Nb, Cr, Mn, Sn, and Zr are elements that prevent ion elution from the magnetic metal powder 22 which is to be covered and are excellent in so-called elution resistance. Therefore, by using an oxide, a composite oxide, or a composite of these elements as the coating layer 24, it is possible to improve extraction performance of the biological substance while securing the elution resistance. The coating layer 24 may include a plurality of layers formed of oxides having different elements or the like.

It is desirable that the coating layer 24 does not capture substances that are not to be extracted, such as impurities. From this viewpoint, the coating layer 24 preferably contains a substance called a blocking substance together with the above preferred substances in the coating layer 24. Examples of the blocking substance include polyethylene glycol, albumin, and dextrin.

The coating layer 24 may contain inevitable impurities as long as the effects thereof are not impaired. For example, when a silicon oxide is used as the oxide material, examples of the inevitable impurities include C, N, and P.

The substance or composition constituting the coating layer 24 can be confirmed by, for example, EDX analysis, or Auger electron spectroscopy measurement.

In a depth direction of the magnetic bead 2, the structure of the coating layer 24 may be any of a single layer made of a single substance, a single layer made of a plurality of substances, composites, or mixtures, or a plurality of layers having different compositions. The surface of the coating layer 24 may be formed of either a single substance or a plurality of substances.

The average thickness t of the coating layer 24 is 20 nm or more, preferably 30 nm or more and 500 nm or less, and more preferably 40 nm or more and 200 nm or less. Accordingly, it is possible to sufficiently prevent the elution of the iron ions and the like due to exposure of the magnetic metal powder 22. Further, it is possible to prevent a decrease in the magnetization per volume of the magnetic bead 2 and to prevent a decrease in the moving speed of the magnetic bead 2.

In addition to the above effects, by setting the average thickness t of the coating layer 24 within the above range, the coercive force Hc of the magnetic bead 2 can be reduced. That is, the average thickness t of the coating layer 24 affects the magnetism of the magnetic metal powder 22. As a result, the coercive force Hc of the magnetic bead 2 decreases. One of the reasons why such an effect is obtained is that, by setting the average thickness t of the coating layer 24 to a predetermined thickness or more, a certain stress change occurs in the magnetic metal powder 22, and accordingly, magnetic wall movement due to the external magnetic field is likely to occur in the magnetic metal powder 22. It is considered that the coercive force Hc of the magnetic bead 2 decreases due to ease of occurrence of the magnetic wall movement.

In particular, when the magnetic metal powder 22 contains the amorphous structure or the nanocrystalline structure, the magnetic wall contained in the magnetic metal powder 22 is particularly likely to move. This tendency is more remarkable in the amorphous structure. Therefore, when the magnetic metal powder 22 contains these structures and the average thickness t of the coating layer 24 is set within the above range, the coercive force Hc of the magnetic bead 2 can be particularly decreased.

The thickness of the coating layer 24 can be measured, for example, based on a cross-sectional observation image of the magnetic bead 2 by using a transmission electron microscope, a scanning electron microscope, or the like. The average thickness t of the coating layer 24 can be calculated by acquiring a plurality of observation images and averaging measured values from an image process or the like. For example, the average thickness t is a value obtained by measuring the thickness of the coating layer 24 at five or more positions for one magnetic bead 2, obtaining an average value of the thickness, and then averaging the average values for ten or more magnetic beads 2.

The thickness of the coating layer 24 can also be measured by performing composition analysis in the depth direction using ion etching in electron spectroscopy for chemical analysis (ESCA).

Here, the present inventor finds that there is a correlation between the average thickness t of the coating layer 24 and the coercive force Hc of the magnetic bead 2.

FIG. 2 is a graph showing the correlation between the average thickness t of the coating layer 24 and the coercive force Hc of the magnetic bead 2. In the graph shown in FIG. 2, a horizontal axis represents the average thickness t of the coating layer 24, and a vertical axis represents the coercive force Hc of the magnetic bead 2.

As shown in FIG. 2, it is found that when the average thickness t of the coating layer 24 increases, the coercive force Hc of the magnetic bead 2 decreases. Specifically, when the average thickness t of the coating layer 24 increases, the coercive force Hc decreases.

When the average thickness t of the coating layer 24 is less than the lower limit value, the coercive force increases, and the re-dispersibility of the magnetic bead 2 decreases. A coverage of the coating layer 24 is likely to decrease, and an absorption amount of the biological substance may decrease, or iron ions or the like may be likely to be eluted when the magnetic bead 2 comes into contact with an acidic solution. Further, the coating layer 24 may be more likely to be broken or peeled. On the other hand, although the average thickness t of the coating layer 24 may exceed the upper limit value, but the volume ratio of the coating layer 24 to the entire volume of the magnetic bead 2 increases, and the magnetization per volume of the magnetic bead 2 may decrease.

The average thickness t of the coating layer 24 is also in correlation with the re-dispersibility of the magnetic bead 2 in a liquid. When the average thickness t of the coating layer 24 is within the above range, as described above, the coercive force can be sufficiently decreased, and accordingly, the residual magnetization is also kept to be low. In this case, when the application of the external magnetic field is turned off, the aggregation of the magnetic beads 2 is prevented. Therefore, the re-dispersibility of the magnetic bead 2 can be enhanced.

When the average thickness t of the coating layer 24 is within the above range, the residual magnetization of the magnetic bead 2 is preferably 0.2 emu/g or less, and more preferably 0.001 emu/g or more and 0.1 emu/g or less. When the residual magnetization of the magnetic bead 2 is within the above range, the aggregation of the magnetic beads 2 due to magnetism can be reduced to a particularly low level. That is, the re-dispersibility of the magnetic bead 2 is particularly good.

### 2. Method of Manufacturing Magnetic Bead

Next, an example of a method of manufacturing the magnetic bead 2 will be described.

The method of manufacturing the magnetic bead 2 includes a magnetic metal powder manufacturing step of manufacturing the magnetic metal powder 22, a classification step of classifying the magnetic metal powder 22 so as to have a predetermined particle diameter and a predetermined particle diameter distribution, and a coating layer forming step of forming the coating layer 24 on the magnetic metal powder 22 subjected to the classification step. Hereinafter, each step will be described.

### 2.1. Magnetic Metal Powder Manufacturing Step

The magnetic metal powder 22 is manufactured by a method in accordance with a general metal powder manufacturing method. Examples of the manufacturing method include a melting process of melting and solidifying a metal to form a powder, a chemical process of manufacturing a powder by a reduction method, a carbonyl method, or the like, and a mechanical process of mechanically pulverizing a material having a larger shape such as an ingot to obtain a powder. Among these, the magnetic metal powder 22 is suitably manufactured by the melting process.

In the manufacturing method using the melting process, an atomization method is exemplified as a representative manufacturing method. In this method, a molten metal having a desired composition formed by melting is sprayed to form a powder.

The atomization method is a method in which the molten metal is rapidly solidified by colliding with a fluid (liquid or gas) injected at a high speed to be powdered, and is classified into a water atomization method, a high-pressure water atomization method, a rotary water atomization method, a gas atomization method, and the like depending on a type of a cooling medium and a device configuration. By manufacturing the metal powder using such an atomization method, the magnetic metal powder 22 can be efficiently manufactured. Further, in the high-pressure water atomization method, the rotary water atomization method, and the gas atomization method, a particle shape of the metal powder is close to a spherical shape due to an action of surface tension. Among these, in the high-pressure water atomization method or the high-speed rotary water atomization method, fine molten metal droplets are formed, and thereafter, the molten metal droplets are rapidly cooled and solidified by a high-speed water stream, so that a rapidly cooled powder close to a spherical shape and having a fine particle diameter can be obtained. In these manufacturing methods, since the molten metal can be cooled at an extremely high cooling rate of about 103° C./sec to 107° C./sec, solidification can be achieved in a state in which disordered atomic arrangement in the molten metal is highly maintained. Therefore, a powder containing the amorphous structure can be efficiently manufactured. By appropriately heat-treating the amorphous powder obtained in this manner, a powder containing the nanocrystalline structure can be obtained.

As a manufacturing method using the chemical process, a carbonyl method is a representative example. In particular, the carbonyl method is known as a manufacturing method of obtaining a spherical powder containing pure Fe or pure Ni. In particular, the pure Fe powder obtained by the carbonyl method has high saturation magnetization. On the other hand, particles produced by the carbonyl method may not have a sufficient Vickers hardness.

After the magnetic metal powder 22 is manufactured as described above, the classification step is performed as necessary, and then the coating layer forming step is performed. The order of the classification step and the coating layer forming step may be reversed.

### 2.2. Classification Step

In the classification step, the magnetic metal powder 22 obtained in the magnetic metal powder manufacturing step is classified to adjust the particle diameter and the particle diameter distribution.

Examples of the classification method include a method using a sieve, a method using a difference in moving distance due to a centrifugal force in a fluid such as air or water, and a method using a difference in settling velocity due to the gravity in a fluid (gravity classification). For classification in a fluid, a method of classification in a gas such as air is generally referred to as dry classification (wind classification), and classification in a liquid such as water is generally referred to as wet classification. Classification by a so-called cyclone method, a rotor method, or the like using a difference in moving distance due to a centrifugal force is used in both dry classification and wet classification. The classification in the liquid is more preferred from the viewpoint of improving the dispersibility in the fluid and preventing the aggregation of particles.

### 2.3. Coating Layer Forming Step

In the coating layer forming step, the coating layer 24 is formed on the particle surface of the magnetic metal powder 22.

A method of forming the coating layer 24 is not particularly limited. Examples thereof include wet forming methods such as a sol-gel method and a coupling agent treatment, and dry forming methods such as an atomic layer deposition (ALD) method, a chemical vapor deposition (CVD) method, and ion plating. Among these, in the formation of the coating layer 24 made of the oxide material, a Stober method, which is a kind of sol-gel method, or the above-described ALD method can be mainly used.

The Stober method is a method of forming monodisperse particles by hydrolyzing a metal alkoxide. When the coating layer 24 is made of the silicon oxide, the coating layer 24 can be formed by a hydrolysis reaction of a silicon alkoxide.

Specifically, first, the magnetic metal powder 22 is dispersed in an alcohol solution containing a silicon alkoxide. Examples of the alcohol solution include lower alcohols such as ethanol and methanol. An addition ratio of the alcohol to the silicon alkoxide may be 10 parts by weight or more and 50 parts by weight or less with respect to 1 part by weight of, for example, tetraethoxysilane. The addition ratio of the silicon alkoxide to the magnetic metal powder 22 may be 0.01 parts by weight or more and 0.1 parts by weight or less when an amount of the magnetic metal powder 22 is 1 part by weight.

Examples of the silicon alkoxide include tetramethoxysilane (TMOS), tetraethoxysilane (TEOS), tetraisopropoxysilane, tetrapropoxysilane, tetrakis(trimethylsilyloxy)silane, tetrabutoxysilane, tetraphenoxysilane, and tetrakis(2-ethylhexyloxy)silane. As the silicon alkoxide, TEOS is particularly preferably used.

Next, ammonia water is supplied as a catalyst for promoting a reaction to cause hydrolysis. Accordingly, a dehydration condensation reaction occurs between hydrolyzates or between the hydrolyzates and the silicon alkoxide, and a —Si—O—Si— bond is formed on the particle surface, thereby forming a silicon oxide film.

Before and after the ammonia water is supplied, the magnetic metal powder 22 and the alcohol solution are preferably stirred using an ultrasonic wave applying device or the like. By performing stirring in each step in this way, uniform dispersion of particles can be promoted, and the silicon oxide film can be uniformly formed on the particle surface. The stirring is preferably performed for a period of time longer than a period of time during which the hydrolysis reaction of the silicon alkoxide sufficiently proceeds.

In the above description, an order is that the magnetic metal powder 22 is dispersed in the alcohol solution containing the silicon alkoxide and then the ammonia water is supplied, but the present disclosure is not limited thereto. For example, an order may be that the alcohol solution containing the silicon alkoxide is mixed after the ammonia water is mixed with the alcohol solution in which the magnetic metal powder 22 is dispersed. In such a case, the alcohol solution containing the silicon alkoxide may be added several times. When the alcohol solution containing the silicon alkoxide is added several times, the above-described stirring may be performed every time the alcohol solution is added, or the alcohol solution may be added to the solution under stirring.

As a material having the same effect as that of the ammonia water, triethylamine, triethanolamine, or the like may be used.

In the case of adjusting the thickness of the coating layer 24, the ratio of the silicon alkoxide in the solution may be appropriately changed. For example, the thickness of the coating layer 24 is increased by increasing the ratio of the silicon alkoxide in the solution.

The magnetic bead 2 is obtained by the above steps, and a heat treatment may be applied to the obtained magnetic bead 2 in order to further improve the performance. For example, by heating the magnetic bead 2 at a temperature of 60° C. or higher and 300° C. or lower for 10 minutes or longer and 300 minutes or shorter, it is possible to remove the hydrate remaining in the magnetic bead 2 and to improve the strength of the magnetic bead 2.

Meanwhile, the ALD method is also a method suitable for forming a silicon oxide film. As a specific method of forming the silicon oxide film by the ALD method, there is a method in which the magnetic metal powder 22 is charged into a chamber capable of vacuuming and controlling an atmosphere, a substance called a precursor for forming the silicon oxide film is charged into the chamber, and then the precursor is thermally decomposed to form a silicon oxide on the particle surface of the magnetic metal powder 22. Examples of the precursor include dimethylamine, methylethylamine, diethylamine, trisdimethylaminosilane, bisdiethylaminosilane, and bistertiarybutylaminosilane. According to the ALD method, it is possible to form a dense and thin coating layer 24 by depositing a raw material at an atomic layer level.

By selecting the precursor, it is possible to form an oxide layer other than the silicon oxide layer or a coating layer made of a composite oxide.

### 3. Effects of Magnetic Bead According to Embodiment

As described above, the magnetic bead 2 according to the embodiment includes the magnetic metal powder 22 and the coating layer 24. The coating layer 24 covers the particle surface of the magnetic metal powder 22, has an average thickness of 20 nm or more, and is made of an oxide material. Further, the coercive force of the magnetic bead 2 is 1.0 Oe (80 A/m) or less.

According to such a configuration, since the coercive force is low, the magnetic bead 2 is excellent in re-dispersibility in a dispersion liquid. Therefore, for example, when the magnetic bead 2 to which a biological substance is adsorbed is brought into contact with a washing liquid and washed, the washing efficiency is likely to enhance. Therefore, impurities (contamination) are less likely to remain. Accordingly, a high-purity biological substance can be extracted. When the biological substance adsorbed to the magnetic bead 2 is eluted into an eluate, the elution efficiency can be enhanced. Accordingly, the biological substance can be extracted at a high yield.

The magnetic metal powder 22 preferably contains an amorphous structure or a nanocrystalline structure. Accordingly, the coercive force Hc of the magnetic bead 2 is a particularly low value, which contributes to the improvement of the re-dispersibility of the magnetic bead 2. In the magnetic metal powder 22 containing these structures, the magnetic wall is particularly likely to move. Therefore, by providing the coating layer 24 having a predetermined thickness, the coercive force Hc of the magnetic bead 2 can be particularly decreased.

The magnetic metal powder 22 is preferably made of an alloy containing Fe as a main component. The alloy containing Fe as the main component implements the magnetic metal powder 22 having high saturation magnetization and high magnetic permeability even when the particle diameter is small. Accordingly, it is possible to implement the magnetic bead 2 having a high moving speed due to the action of the external magnetic field and having a large magnetic adsorption force when captured by the external magnetic field. As a result, the time required for magnetic separation can be shortened, and the magnetic bead 2 can be prevented from being mixed into the eluate and becoming impurities.

In the alloy containing Fe as the main component, the Si content is preferably 2.0 mass % or more and 9.0 mass % or less, the B content is preferably 1.0 mass % or more and 5.0 mass % or less, and the Cr content is preferably 1.0 mass % or more and 3.0 mass % or less.

Such a Fe-based alloy is excellent in stability of the amorphous structure and contains Cr, and thus has particularly high corrosion resistance. Therefore, according to the Fe-based alloy having such a composition, it is possible to implement the magnetic metal powder 22 having a low coercive force and less elution of iron ions and the like.

The oxide material constituting the coating layer 24 preferably contains a silicon oxide. The silicon oxide is a substance particularly suitable for the extraction of the nucleic acids such as DNA and RNA, and enables efficient extraction and collection of the nucleic acids by specifically adsorbing the nucleic acids in an aqueous solution containing a chaotropic substance.

The saturation magnetization of the magnetic bead 2 is preferably 50 emu/g or more. Accordingly, since the moving speed of the magnetic bead 2 in a magnetic field can be increased, the time required for the magnetic separation can be shortened. When the saturation magnetization of the magnetic bead 2 is within the above range, a sufficiently high adsorption force can be obtained. Therefore, when a magnetically separated liquid is discharged, discharge of the magnetic bead 2 together with the liquid can be prevented.

The average particle diameter of the magnetic bead 2 is preferably 0.5 μm or more and 50 μm or less. Accordingly, the specific surface area of the magnetic bead 2 can be sufficiently increased, and mass and saturation magnetization of the magnetic bead 2 are suitable for the magnetic separation. As a result, it is possible to obtain the magnetic bead 2 having a specific surface area enabling adsorbing a sufficient amount of the biological substance and exhibiting a magnetic attractive force excellent in separability in the magnetic separation. The aggregation of the magnetic beads 2 can be reduced, and the dispersibility can be enhanced.

The magnetic bead according to the present disclosure is described above based on the illustrated embodiment, but the present disclosure is not limited thereto. For example, the magnetic bead according to the present disclosure may be a bead in which any component is added to the above-described embodiment.

### EXAMPLES

Next, specific Examples of the present disclosure will be described.

### 4. Production of Magnetic Bead

### 4.1. Example 1

First, a magnetic metal powder having an alloy composition represented by a composition formula shown in Table 1 was produced by a high-pressure water atomization method. Metal structure analysis of the obtained powder was performed by using an X-ray diffraction method. It is confirmed that a main metal structure of the powder is an amorphous structure.

Thereafter, a silicon oxide (SiO₂) film was formed on the particle surface of the magnetic metal powder by a Stober method to obtain a magnetic bead. In the Stober method, first, 100 g of the magnetic metal powder was dispersed and mixed in 950 mL of ethanol, and a mixed liquid thereof was stirred for 20 minutes by an ultrasonic wave applying device. After stirring, a mixed solution of 30 mL of pure water and 180 mL of ammonia water was added, and the mixture was further stirred for 10 minutes. Thereafter, a mixed liquid of tetraethoxysilane (TEOS) and 100 mL of ethanol was further added and stirred to form a silicon oxide film on the particle surface of the magnetic metal powder. Thereafter, the obtained silicon oxide film was washed with ethanol and acetone. After washing, a resultant was dried at 65° C. for 30 minutes, and further heated at 200° C. for 90 minutes. Accordingly, the magnetic bead was obtained.

For the obtained magnetic bead, a measurement of the average particle diameter D50 by a laser diffraction method, a measurement of the average thickness t of the coating layer by cross-sectional observation, and measurements of the saturation magnetization, the residual magnetization, and the coercive force were performed. Results of the structure analysis and results of various measurements of the magnetic beads are shown in Table 1.

### 4.2. Examples 2 to 4 and Comparative Examples 1 and 2

Magnetic beads were obtained in the same manner as in Example 1 except that the average thickness t of the coating layer was adjusted to values shown in Table 1 by changing an addition amount of TEOS and a stirring time of the mixed liquid in the formation of the coating layer. Each of the magnetic beads was subjected to the structure analysis and various measurements in the same manner as in Example 1. The results are shown in Table 1.

### 4.3. Examples 5 to 7 and Comparative Examples 3 to 5

Magnetic beads were produced in the same manner as in Example 1, except that a magnetic metal powder having an alloy composition represented by a composition formula shown in Table 2 was used and characteristics were as shown in Table 2.

### 4.4. Examples 8 to 10 and Comparative Examples 6 to 8

Magnetic beads were produced in the same manner as in Example 1, except that a magnetic metal powder having an alloy composition represented by a composition formula shown in Table 3 was used and characteristics were as shown in Table 3. In Comparative Examples 7 and 8, the amorphous structure was crystallized by a heat treatment. Accordingly, in Comparative Examples 7 and 8, the coercive force was increased as compared with those before the heat treatment.

### 5. Evaluation of Magnetic Bead

### 5.1. Evaluation of Re-dispersibility

First, 0.5 g of the magnetic bead obtained in each of Examples and Comparative Examples was charged into a 1.5 mL tube and then dispersed in 0.5 mL of pure water to prepare a magnetic bead dispersion liquid. Next, the magnetic bead dispersion liquid was stirred with a vortex mixer for 30 minutes. 50 μL of a magnetic bead suspension immediately after stirring was taken out and charged into another container, and a particle size distribution of the magnetic bead was measured. A Microtrac MT3000II manufactured by Microtrac BEL Corporation was used for the measurement. The average particle diameter D50 was calculated based on measurement result, which was defined as an initial average particle diameter.

Next, a magnet was brought close to the tube, an external magnetic field was applied to the magnetic bead suspension, and magnetic collection was performed to fix the magnetic bead to an inner wall of the container. As the magnet, a neodymium magnet having a surface magnetic flux density of 1.3 T was used. Then, the sample was allowed to stand for 30 minutes in a magnetically collected state.

Next, the magnet was moved away from the tube, and contents contained in the tube were stirred with a vortex mixer for 5 seconds. 50 μL of a magnetic bead suspension immediately after stirring was taken out and charged into another container, and the particle size distribution of the magnetic bead was measured. The average particle diameter D50 was calculated based on the measurement result, which was defined as an average particle diameter after the magnetic collection.

Then, a difference between the initial average particle diameter and the average particle diameter after the magnetic collection was calculated, and a calculation result thereof was used as an index indicating the re-dispersibility and evaluated in light of the following evaluation criteria.
A: the difference in average particle diameter is 0.5 μm or less (re-dispersibility is particularly good).
B: the difference in average particle diameter is more than 0.5 μm and 1.0 μm or less (re-dispersibility is good).
C: the difference in average particle diameter is more than 1.0 μm and 1.5 μm or less (re-dispersibility is poor).
D: the difference in average particle diameter is more than 1.5 μm (re-dispersibility is particularly poor).

The evaluation results are shown in Tables 1 to 3.

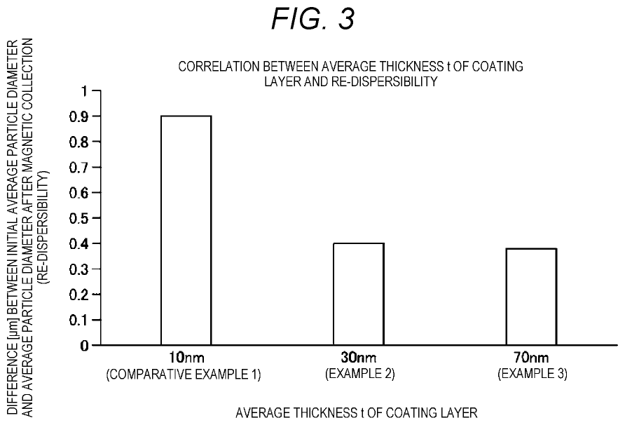

FIG. 3 is a graph showing a correlation between the average thickness t of the coating layer 24 and the evaluation result of the re-dispersibility of the magnetic bead 2. In the graph in FIG. 3, a horizontal axis shown is the average thickness t of the coating layer 24, and a vertical axis is an index indicating the difference between the initial average particle diameter and the average particle diameter after the magnetic collection, that is, the above-described re-dispersibility. In FIG. 3, only the evaluation results in Comparative Example 1, Example 2, and Example 3 are shown.

As shown in FIG. 3, when the average thickness t of the coating layer 24 is 10 nm, the re-dispersibility of the magnetic bead 2 is not sufficient. It is considered that this is because the coverage of the coating layer 24 is low, and accordingly, the aggregation of the magnetic beads 2 occurs. On the other hand, when the average thickness t of the coating layer 24 is 30 nm or 70 nm, the re-dispersibility of the magnetic bead 2 is good. It is considered that this is because the coverage of the coating layer 24 is high, and accordingly, the aggregation of the magnetic beads 2 is reduced. When the average thickness t of the coating layer 24 is within this range, as described above, the coercive force is 1.0 Oe (80 A/m) or less, and accordingly, the residual magnetization is also reduced. From these facts, it is presumed that when the average thickness t of the coating layer 24 is 20 nm or more, the re-dispersibility of the magnetic bead 2 is high.

### 5.2. Evaluation of Yield and Purity of Nucleic Acid

First, Human genomic DNA was prepared as a nucleic acid model, and lysozyme was prepared as an impurity model.

Next, the magnetic bead obtained in each of Examples and Comparative Examples was dispersed in pure water and stirred to prepare a magnetic bead suspension. A content of the magnetic bead in the magnetic bead suspension was 53.17 mass %.

Next, reagents other than the nucleic acid was left to stand until a temperature thereof reached room temperature, and then the reagents were charged into the tube in the following order.
Pure water: 10 μL
Nucleic acid dispersion liquid having a concentration of 0.1 μg/μL: 75 μL
Solution and adsorption liquid: 750 μL
Lysozyme aqueous solution having a concentration of 10 μg/μL: 15 μL
Magnetic bead suspension: 40 μL

Next, the contents in the tube were stirred with a vortex mixer for 10 minutes, and then the tube was set in a magnetic stand and left to stand for 30 seconds. Then, once the magnetic bead was magnetically collected, the supernatant was removed.

Next, 900 μL of a washing liquid was added to the tube, and the mixture was stirred for 5 seconds with a vortex mixer and then subjected to centrifugation. Thereafter, the tube was set in the magnetic stand and left to stand for 30 seconds. Then, once the magnetic bead was magnetically collected, the supernatant was removed. Thereafter, the addition of the washing liquid, the magnetic collection, and the removal of the supernatant were performed again.

Next, 900 μL of a 70% ethanol aqueous solution was added to the tube, and the mixture was stirred with a vortex mixer for 5 seconds and then subjected to centrifugation. Thereafter, an operation of absorbing and returning the contents in the tube with a pipette was performed once. Thereafter, the tube was set in the magnetic stand and left to stand for 30 seconds. Then, once the magnetic bead was magnetically collected, the supernatant was removed. Thereafter, the addition of the ethanol aqueous solution, the magnetic collection, and the removal of the supernatant were performed again. Next, the tube was subjected to centrifugation, and then the remaining supernatant was removed.

Next, 100 μL of pure water was added to the tube, followed by stirring with a vortex mixer for 10 minutes to elute the nucleic acid. Thereafter, the tube was set in the magnetic stand and left to stand for 30 seconds. Then, once the magnetic bead was magnetically collected, the eluate containing the nucleic acid was collected in another tube.

Next, the collected eluate was set in an absorptiometer, and a concentration of the nucleic acid in the eluate was quantified based on an absorbance at a wavelength of 260 nm. Then, a nucleic acid collection amount was calculated based on the obtained concentration, and a ratio of the nucleic acid collection amount to a nucleic acid charged amount was calculated as the yield of the nucleic acid. Since a nucleic acid base has an absorption maximum in the vicinity of 260 nm, the absorbance at a wavelength of 260 nm is used to quantify the concentration of the nucleic acid. Then, the calculated yield of the nucleic acid was evaluated in light of the following evaluation criteria.
A: the yield of the nucleic acid is 80% or more.
B: the yield of the nucleic acid is 60% or more and less than 80%.
C: the yield of the nucleic acid is 40% or more and less than 60%.
D: the yield of the nucleic acid is less than 40%.

The evaluation results are shown in Tables 1 to 3.

The absorbance at a wavelength of 260 nm is denoted by A₂₆₀, and the absorbance at a wavelength of 280 nm is denoted by A₂₈₀. Substances (impurities) other than the nucleic acid, such as proteins, contained in the eluate have an absorption maximum in the vicinity of a wavelength of 280 nm. Therefore, a ratio of A₂₆₀/A₂₈₀ was calculated as an index of the purity of the nucleic acid. Then, the calculated A₂₆₀/A₂₈₀ was evaluated in light of the following evaluation criteria.
A: the ratio of A₂₆₀/A₂₈₀ is 1.8 or more.
B: the ratio of A₂₆₀/A₂₈₀ is 1.6 or more and less than 1.8.
C: the ratio of A₂₆₀/A₂₈₀ is 1.4 or more and less than 1.6.
D: the ratio of A₂₆₀/A₂₈₀ is less than 1.4.

The evaluation results are shown in Tables 1 to 3.

### 5.3. Evaluation of Corrosion Resistance of Magnetic Bead

First, 50 mg of the magnetic bead obtained in each of Examples and Comparative Examples was charged into a 1.5 mL tube and then dispersed in 40 mL of pure water to prepare a magnetic bead dispersion liquid.

Next, 160 μL of 5 mM hydrochloric acid was added to the tube, and then the contents were stirred for 30 minutes with a vortex mixer.

Next, 600 μL of a standard solution prepared by the following method was added to the tube to prepare a sample to be measured.

The method for preparing the standard solution is as follows. First, 10 mL of a 60 mM hydroxylamine solution is charged into a 110 mL screw tube. Next, 10 mL of a 1 M sodium acetate solution is added to the screw tube. Next, 10 mL of a 1,10-phenanthroline solution having a concentration of 0.25 mass % is added to the screw tube. Then, pure water is added such that a total amount is 100 mL. The standard solution is prepared as described above.

Next, the sample to be measured was set in an absorptiometer, and an iron ion concentration was quantified based on an absorbance at a wavelength of 510 nm. Then, the obtained iron ion concentration was evaluated in light of the following evaluation criteria.
A: the iron ion concentration is 0.5 ppm or less.
B: the iron ion concentration is more than 0.5 ppm and 1.0 ppm or less.
C: the iron ion concentration is more than 1.0 ppm and 3.0 ppm or less.
D: the iron ion concentration is more than 3.0 ppm.

The evaluation results are shown in Tables 1 to 3.

TABLE 1

| | | | Example | Example | Example | Example | Comparative | Comparative |
|---|---|---|---|---|---|---|---|---|
| | | | 1 | 2 | 3 | 4 | Example 1 | Example 2 |
| Characteristics of | Alloy composition | — | Fe₇₃Si₁₁Cr₂B₁₁C₃ (atomic %) | | | | | |
| magnetic bead | | | (Fe_{87.8}Si_{6.7}Cr_{2.2}B_{2.6}C_{0.8} (mass %) | | | | | |
| | Main metal structure | | Amorphous structure | | | | | |
| | Saturation magnetization | emu/g | 143 | 142 | 140 | 137 | 145 | 145 |
| | Average particle | μm | | | 5 | | | |
| | Average thickness t of | nm | 20 | 30 | 70 | 100 | 0 | 10 |
| | coating layer | | | | | | | |
| | Coercive force | Oe | 0.43 | 0.58 | 0.20 | 0.12 | 2.89 | 1.02 |
| | | A/m | 34 | 46 | 16 | 9.4 | 230 | 81 |
| | Residual magnetization | emu/g | 0.027 | 0.037 | 0.013 | 0.008 | 0.185 | 0.065 |
| Evaluation result of | Re-dispersibility | — | A | A | A | A | C | B |
| magnetic bead | Yield of nucleic acid | — | A | A | A | A | D | B |
| | Purity of nucleic acid | — | B | B | A | A | D | B |
| | Corrosion resistance | — | B | A | A | A | D | B |

TABLE 2

| | | | Example | Example | Example | Comparative | Comparative | Comparative |
|---|---|---|---|---|---|---|---|---|
| | | | 5 | 6 | 7 | Example 3 | Example 4 | Example 5 |
| Characteristics of | Alloy composition | — | Fe₈₁Si₅B₁₂C₂ (atomic %) | | | | | |
| magnetic bead | | | (Fe_{93.9}Si_{2.9}B_{2.7}C_{0.5} (mass %) | | | | | |
| | Main metal structure | | Amorphous structure | | | | | |
| | Average particle | μm | 10 | | | | | |
| | Average thickness t of coating | nm | 20 | 30 | 70 | 0 | 5 | 10 |
| | layer | | | | | | | |
| | Coercive force | Oe | 0.98 | 0.57 | 0.06 | 2.93 | 2.22 | 1.70 |
| | | A/m | 78 | 45 | 5 | 233 | 177 | 135 |
| Evaluation result of | Re-dispersibility | — | A | A | A | C | C | B |
| magnetic bead | Yield of nucleic acid | — | A | A | A | D | A | B |
| | Purity of nucleic acid | — | B | B | A | D | C | B |
| | Corrosion resistance | — | B | A | A | D | C | B |

TABLE 3

| | | | Example | Example | Example | Comparative | Comparative | Comparative |
|---|---|---|---|---|---|---|---|---|
| | | | 8 | 9 | 10 | Example 6 | Example 7 | Example 8 |
| Characteristics of | Alloy composition | — | Fe_{73.5}Si_{13.5}Cu₁B₉Nb₃ (atomic %) | | | | | |
| magnetic bead | | | (Fe_{83.4}Si_{7.7}Cu_{1.3}B_{2.0}Nb_{5.7} (mass %) | | | | | |
| | Main metal structure | | Amorphous structure | | | Crystalline structure | | |
| | Average particle | μm | 20 | | | | | |
| | Average thickness t of coating | nm | 20 | 40 | 100 | 0 | 50 | 500 |
| | layer | | | | | | | |
| | Coercive force | Oe | 0.92 | 0.30 | 0.01 | 2.75 | 17.60 | 35.00 |
| | | A/m | 73 | 24 | 0.9 | 219 | 1401 | 2785 |
| Evaluation result of | Re-dispersibility | — | A | A | A | C | C | D |
| magnetic bead | Yield of nucleic acid | — | A | A | A | D | B | A |
| | Purity of nucleic acid | — | B | A | A | D | C | D |
| | Corrosion resistance | — | B | A | A | D | B | C |

As is clear from Tables 1 to 3, it is confirmed that the magnetic beads in Examples are excellent in re-dispersibility in a dispersion liquid, and are capable of extracting a high-purity biological substance at a high yield. It is also found that the magnetic beads in Examples have less elution of iron ions and are excellent in corrosion resistance.

What is claimed is:

1. A magnetic bead comprising:
a magnetic metal powder; and
a coating layer that covers a particle surface of the magnetic metal powder, has an average thickness of 20 nm or more, and is made of an oxide material, wherein
a coercive force is 1.0 Oe, which is equal to 80 A/m, or less.

2. The magnetic bead according to claim 1, wherein
the magnetic metal powder contains an amorphous structure or a nanocrystalline structure.

3. The magnetic bead according to claim 1, wherein
the magnetic metal powder is made of an alloy containing Fe as a main component.

4. The magnetic bead according to claim 3, wherein
the alloy has a Si content of 2.0 mass % or more and 9.0 mass % or less, a B content of 1.0 mass % or more and 5.0 mass % or less, and a Cr content of 1.0 mass % or more and 3.0 mass % or less.

5. The magnetic bead according to claim 1, wherein
the oxide material contains a silicon oxide.

6. The magnetic bead according to claim 1, wherein
the magnetic bead has a saturation magnetization of 50 emu/g or more.

7. The magnetic bead according to claim 1, wherein
the magnetic bead has an average particle diameter of 0.5 μm or more and 50 μm or less.
